(19) United States
(12) Patent Application Publication
(10) Pub. No.: US 2003/0084540 A1
(43) Pub. Date: May 8, 2003

(54) Attachable/detachable multiple adjustable cylindrical tubes apparatus

(76) Inventor: James Mayfield, Queens, NY (US)

Correspondence Address: James Mayfield, 64-39C 186th Lane, Apt.#1C, Fresh Meadows, NY, 11365, US

(21) Appl. No.: 09/994,591

(22) Filed: Nov. 5, 2001

(51) Int. Cl. E05B 1/00

(52) U.S. Cl. 16/110.1

(57) ABSTRACT

An Attachable/Detachable Multiple Adjustable Cylindrical Tubes Apparatus for vehicles. Apparatus clamps onto a vehicle's frame. The Apparatus is lightweight, simple to operate, detachable and suitable for travel. Cylindrical Adjustable Tubes made of a sturdy material so as to not bend easily and withstand applied pressure when steering and maneuvering vehicle. In addition, protective Fitted Caps cover all tube endings to minimize injury to chaperone or occupant. Cylindrical Adjustable Tubes contain multiple insertion holes, which secure length adjustments. Additionally, when attached to vehicle, the Attachment is designed to not obstruct a pedestrian's walkway. An Apparatus' distance from vehicle when in operation is comparable to the width dual occupant child stroller

### BACKGROUND—FIELD OF INVENTION

This invention relates to children strollers and carriages, particularly to the positioning of a chaperone to a child stroller or carriage and to the steering and maneuvering of children strollers/carriages.

### OBJECTS AND ADVANTAGES

Accordingly, besides the objects and advantages of an Attachable/Detachable Adjustable Multiple Cylindrical Tube Apparatus, several objectives of this invention are to provide a detachable apparatus whereas to allow for a convenient, safe, and economical option to steer and maneuver a child vehicle. Provide an extremely functional detachable instrument to the public. To provide an instrument whereas to increases chaperone/occupant interaction during travel. To provide an instrument that offer protection to occupant, by positioning chaperone alongside vehicle. Advantages of invention are; Increased communication between chaperone and occupant. Increase interaction between chaperone and occupant. Reduce occupant movement. Easy storage. Simple operation. Portable. Adaptable. Designed to fit varying sized structural bars. Additional objectives and advantages are to provide a detachable apparatus that will be functional and operate without damage to vehicle or person(s), that is simple to use, inexpensive to manufacture, can be adaptable for many uses, functional, portable, detachable, and lightweight. Still further objects and advantages will become apparent from a consideration of the ensuing description and accompanying drawings.

### DRAWING FIGURES

In the drawings, closely related figures have the same number but different alphabetic suffixes.

FIG. 1 Shows a side view of a cylindrical elongated tube with affixtures

FIG. 2 Shows top view of a Cylindrical Elongated Tube with affixtures

FIG. 3 Shows multiple cylindrical parts and Knob

FIG. 4 Shows frontal view of an elongated open-face tube with swinging bracket;

FIG. 5 Shows view of an elongated open-face tube with swinging bracket;

FIG. 6 Side view of a cylindrical tube with holes and strap element; cylindrical expenditure affixed;

FIG. 7 View of a strap of material with adhesive representation and buckle and screw;

FIG. 8 View of a strap of material with adhesive representation and buckle without screw;

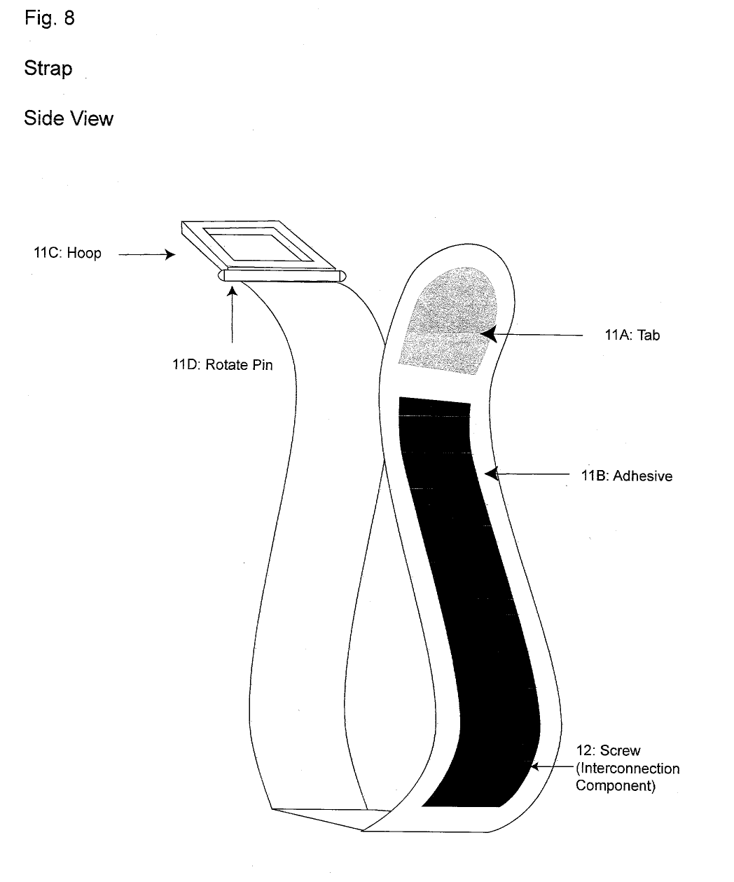

FIG. 9 View of a cylindrical tube with holes and affixtures, surrounded by a cylindrical sleeve;

FIG. 10 Shows a representation of an elongated rod surrounded by a spring with knob attached;

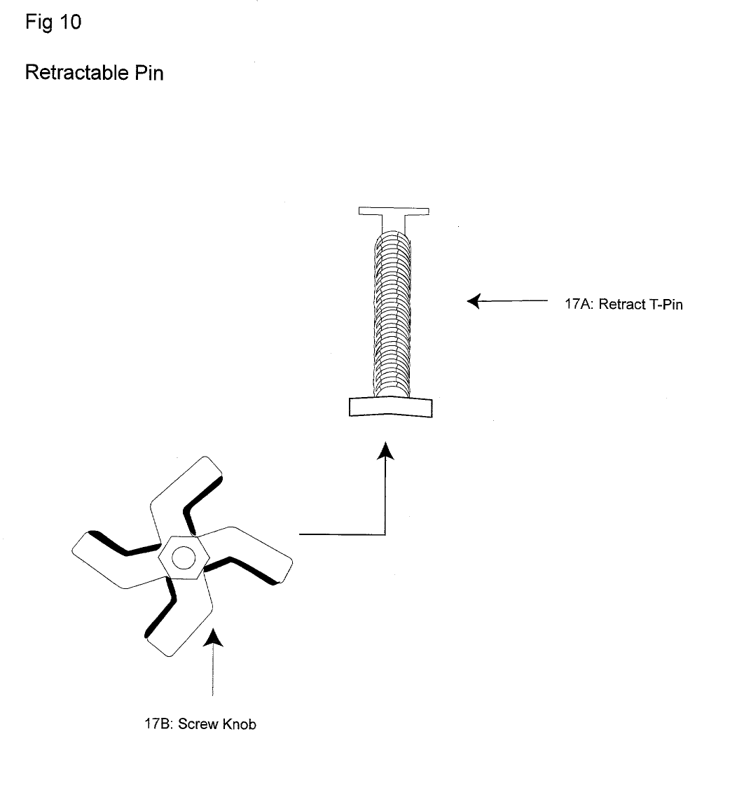

FIG. 11 Side view of a cylindrical tube with multiple curves and cushion cover representation

### REFERENCE NUMERALS

Figure Reference # Item

1 Base Cylindrical Member A

9 Connected Cylindrical Adjustable Member B

6 Connected Counter Weight Cylindrical Adjustable Member C

11 Connected Cylindrical Multiple Curve Member D

1 4 Flat Metal and Pin (Interconnection Component)

1 5 Fitted Cap

1 6 Screw

1 2A Angle hole

2 7 Hinge

2 10 Connection Screw (Interconnection Component)

2 13 Cylindrical Angle Position Adjustment Rod (Interconnection Component)

2 13B Knob

3 Cylindrical Angle Position Adjustment Rod (components view)

3 13C Pin

3 13B Cross Metal Piece and knob element

4 Clamping Apparatus (Front View)

5 Clamping Apparatus (Side View)

5 20 Body

5 20A Holder (Interconnection Component)

5 20C Swing Pin

5 20B Swing-to-Lock

5 20D Holder

6 8A Child Sleeve

6 8B Parent Sleeve

6 9 Swivel Bracket

6 8C Insertion Hole

6 11 Strap

6 11A Tab

6 11B Adhesive Material

6 11C Hoop

6 11D Rotate Pin

6 12 Screw (Interconnection Component)

7 Strap

9 17 Bracket

9 16 Connection Screw

9 16D Rotate Sleeve

9 16E Insert Pin

9 17 Bracket

9 17B Screw Knob

9 17A Retract T-Pin

10 Rod with Knob

9 16A Parent Sleeve

9 8C Insertion Hole

9 16B Child Sleeve

9 8D Retractable Pin

11 18B Grip Cushion

11 19 Insertion Cylinder

9 16 Pin and Knob

10 16 Rotate Knob

### PREFERRED EMBODIMENT—DESCRIPTION

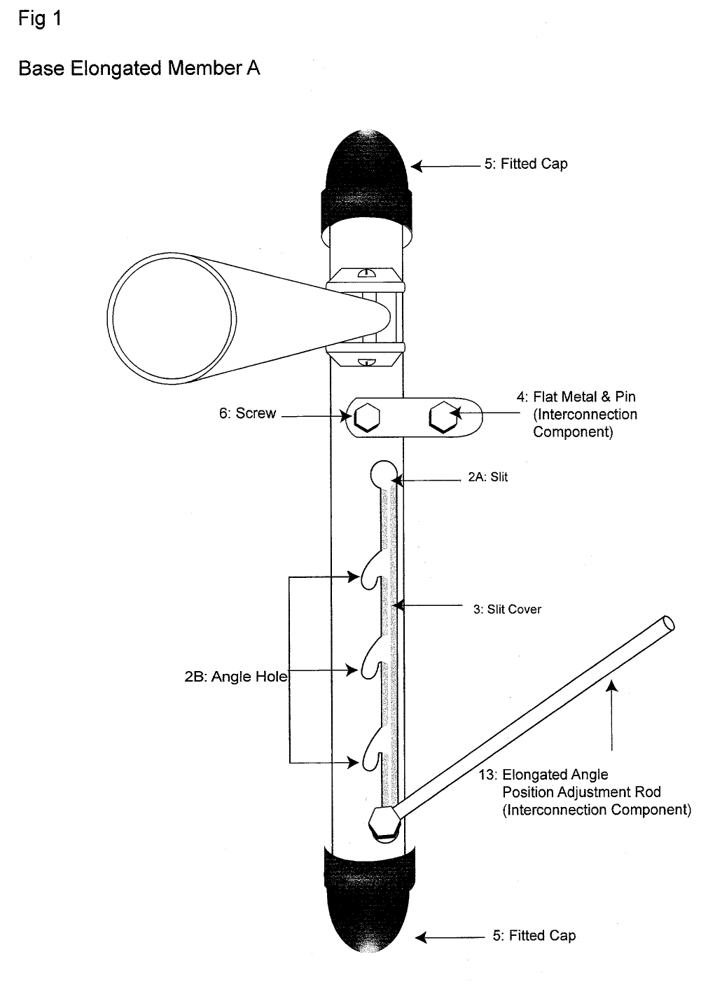

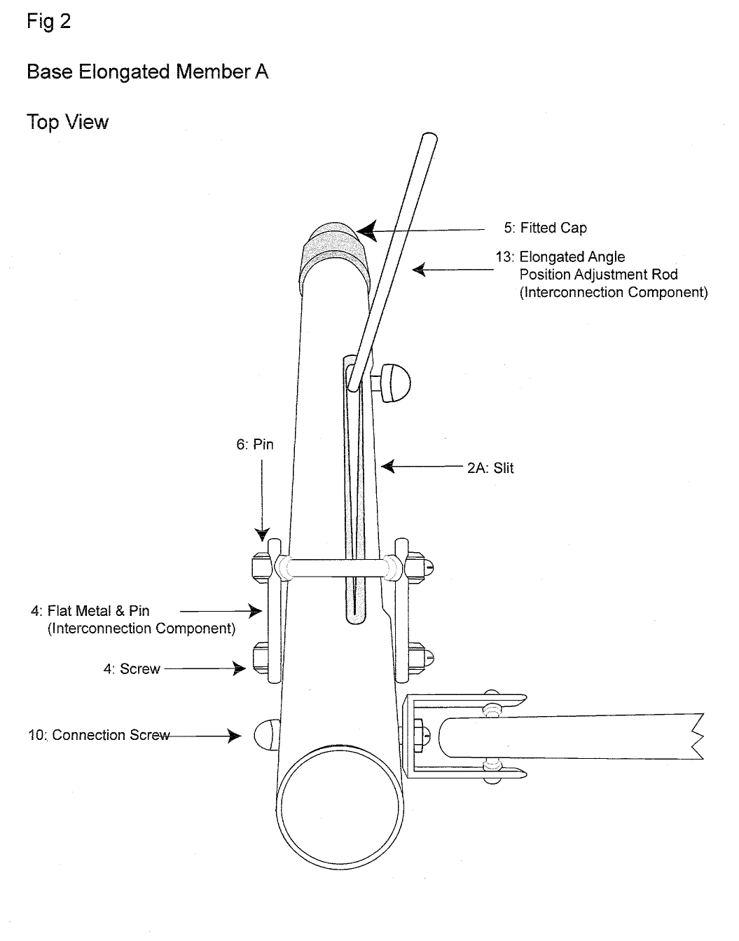

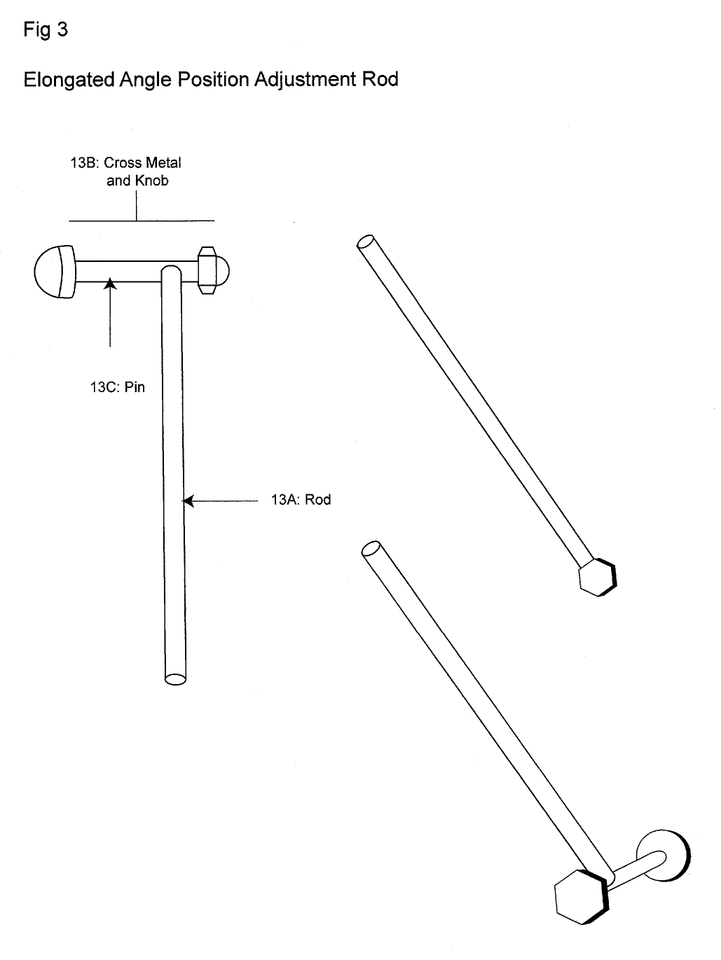

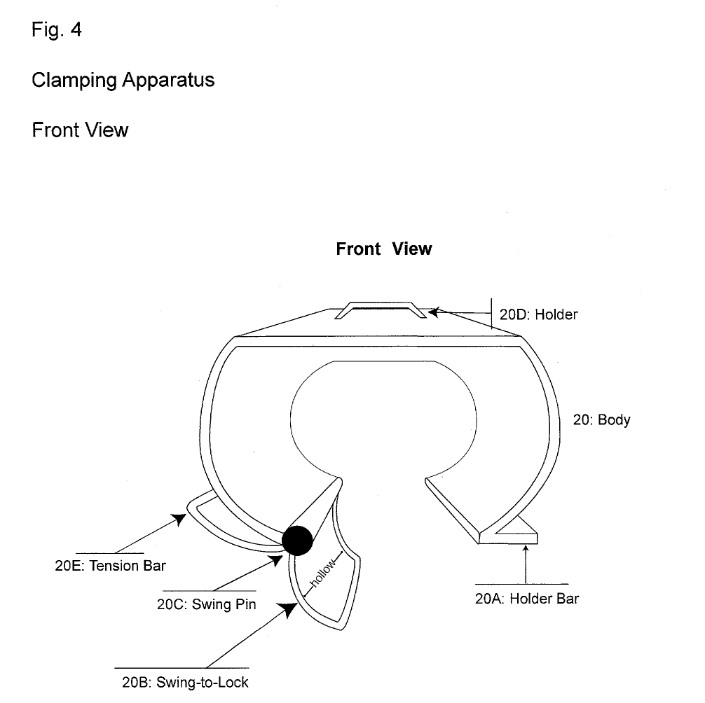

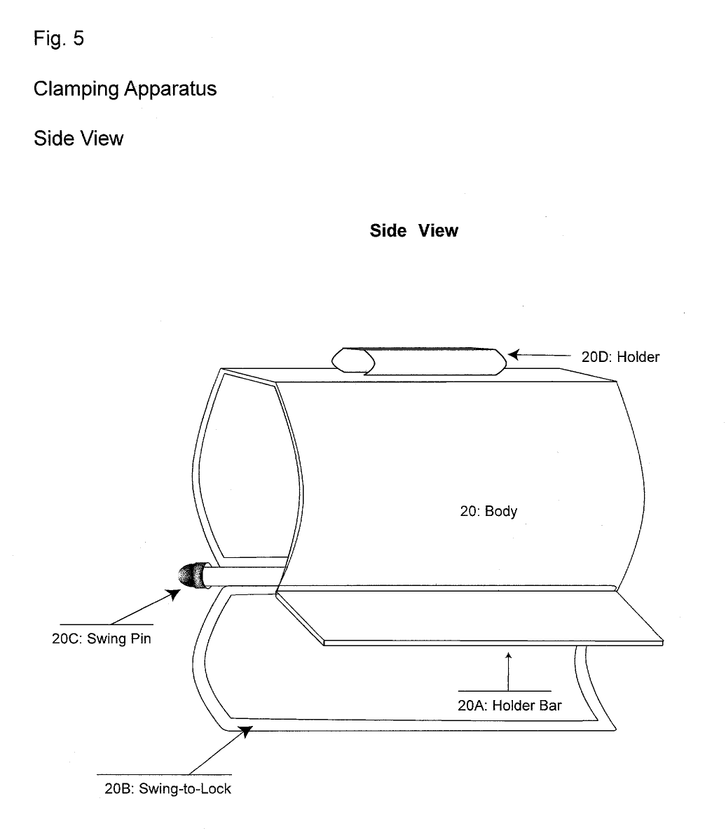

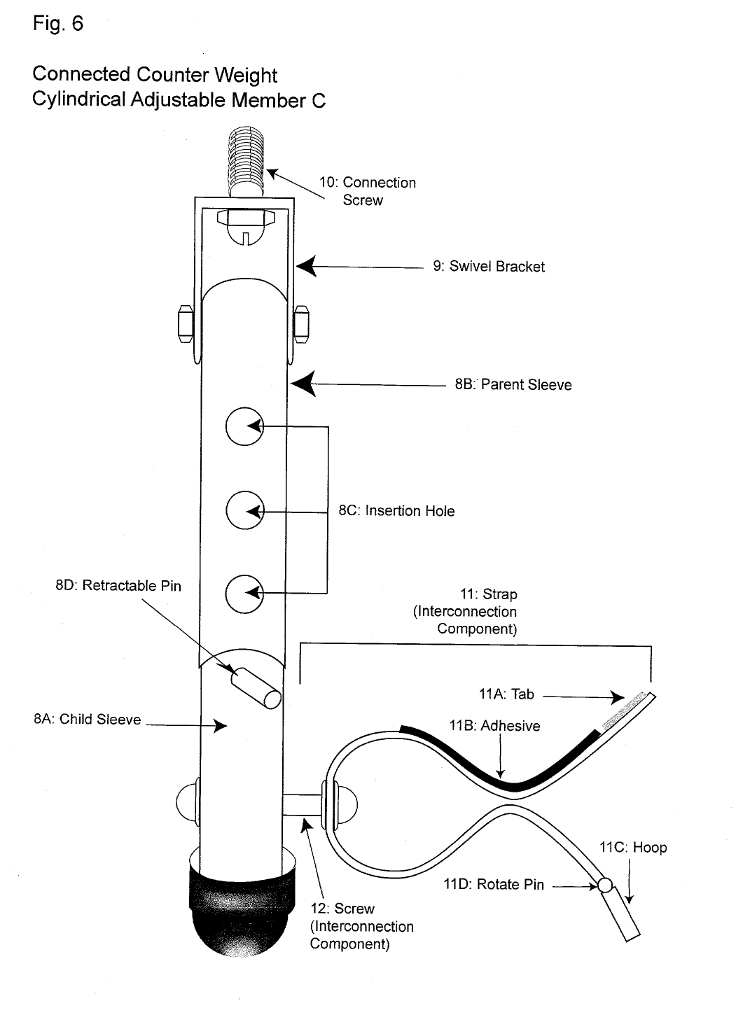

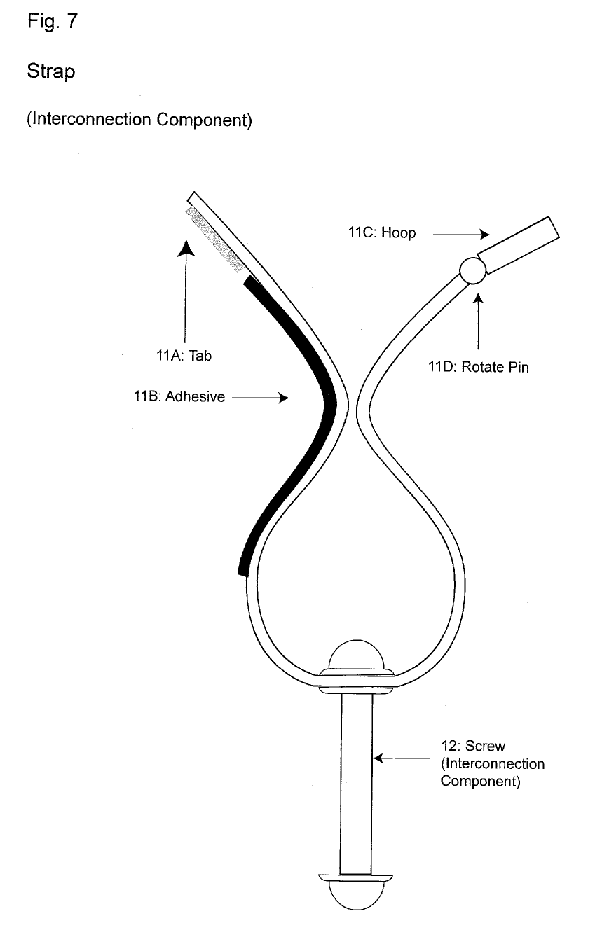

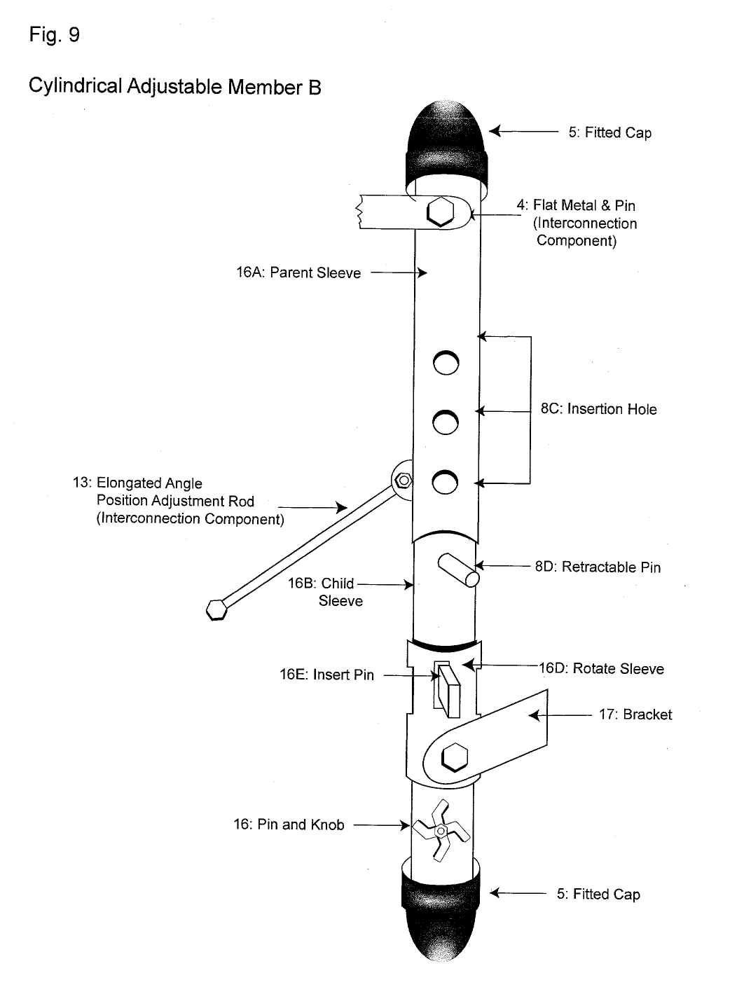

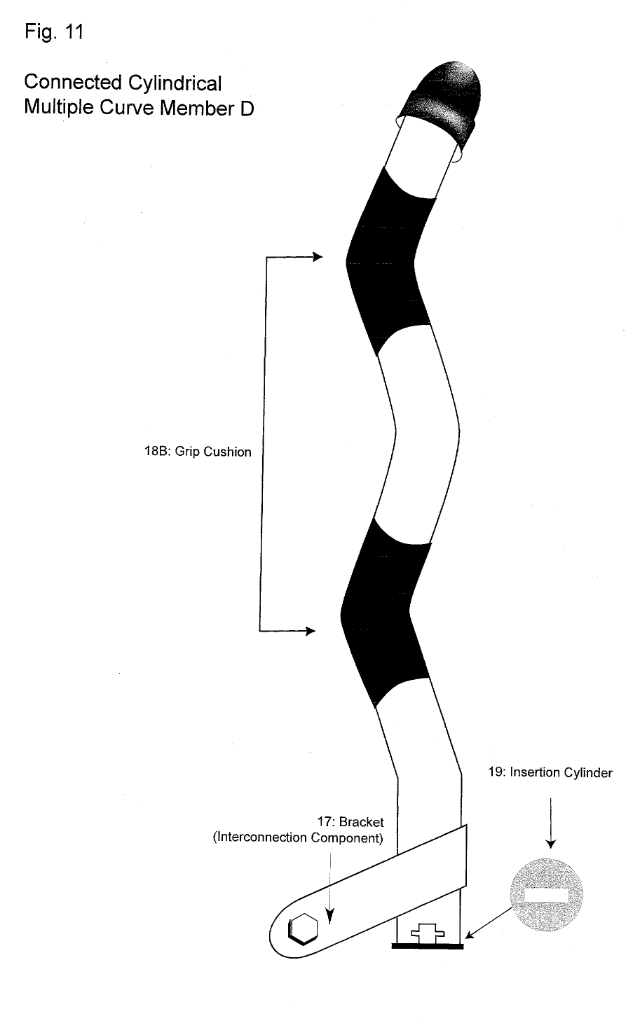

A typical element of a Detachable Multiple Cylindrical Adjustable Length Member Apparatus as means to attach said apparatus to vehicle is illustrated in FIG. 5; side view, FIG. 4; front view. Body (FIG. 5; Ref. 20) of a Clamping element is of an Cylindrical tubular shape. Enclosure of said Clamping element encompass structural bar of said vehicle. Functionality of a Swing-to-Lock Bracket element (FIG. 5; Ref. 20B) and Swing Pin (FIG. 5;Ref. 20C) element enable motion of said Swing-to-Lock Bracket element. Attachment of said (FIG. 5) clamping element to (FIG. 1) Base Cylindrical Adjustable Length Member A accomplished by Hinge element (FIG. 2;Ref. 7) slid into Holder element (FIG. 5; Ref.20D) affixed to said Clamping element. Preferred material for said Cylindrical Adjustable Member A and preceding Cylindrical Members referred in this document is aluminum or alloy. Capping ends of said Cylindrical Adjustable Members (FIG. 1; Ref.5) Fitted Cap element. Preferred material of said Fitted Cap element is rubber. A Slit element (FIG. 1; Ref. 2A, also illustrated in FIG. 2; Ref. 2A) cut from body of said Base Cylindrical Adjustable Member A as means to enable angle positioning of connected (FIG. 9) Cylindrical Adjustable Length Member B. (FIG. 1; Ref. 2B) Angle Hole element in said Base Cylindrical Adjustable Member A to secure angle position. Edges of said Slit element and said Angle Hole element are fitted with a Slit Cover element (FIG. 1; Ref. 3). Preferred material for said Slit Cover element is rubber. Connected to distal end of said Base Cylindrical Adjustable Length Member A, (FIG. 6) Connected Counter-Weight Cylindrical Adjustable Member C. Whereas to balance weight added to vehicle by invention. Interconnection component Connection Screw element (FIG. 2; Ref. 10) secures connection of said Connected Counter-Weight Cylindrical Adjustable Member C to said Base Cylindrical Adjustable Length Member A. Said Connected Counter-Weight Cylindrical Adjustable Member C comprising: Cylindrical Parent Sleeve element (FIG. 6; Ref. 8B) with (FIG. 6; Ref.8C) Insertion Hole element cut within body as means for insertion of a (FIG. 6; Ref.8D) Retractable Pin element to secure adjusted length, whereas to enable adjustment of length of said Connected Cylindrical Adjustable Member C. Said Cylindrical Parent Sleeve element encase Cylindrical Child Sleeve element (FIG. 6; Ref. 8A), as means to enable Cylindrical Child Sleeve motion. Affixed to said Encased Cylindrical Child Sleeve, said Retractable Pin element (FIG. 6;Ref. 8D) as means to secure adjustable length. Operation of said Retractable Pin element described in the proceeding; Push said Pin downward into said Child Sleeve element. Spring element wrapped around Pin, as means to enable said Pin motion, coils. Slide said Encased Cylindrical Child Sleeve within said Cylindrical Parent Sleeve to a (FIG. 6; Ref. 8C) Insertion Hole element. Said Retractable Pin element retracts upward, inserting into said Insertion Hole element. Endings of said Connected Counter Weight Cylindrical Adjustable Member C are fitted with said Fitted Cap element (FIG. 1; Ref. 5). Attaching said Connected Cylindrical Adjustable Member C to vehicle achieved by a (FIG. 6; Ref. 11) Strap element. (FIG. 6; Ref. 11A) Cylindrical Material element wraps around structural bar of a vehicle, extends into a journal hole of a (FIG. 6; Ref. 11C) Hoop element, attach to (FIG. 6; Ref. 11B) Adhesive element as means to enable attachment of said Connected Cylindrical Adjustable Member C. A (FIG. 6; Ref. 11D) Rotate Pin element enables rotation of Hoop element. Said Strap element preferred material for construction is Velcro. Interconnection Screw element (FIG. 6; Ref. 12) secures connection of said Strap element to proximal end of said Connected Cylindrical Member C element. A (FIG. 6; Ref. 9) Rotation Bracket affix to distal end of said Connected Cylindrical Member C and connected to said Connection Screw element as means to enable Rotation of said Connected Cylindrical Member C element. Functionality of interconnection components, Screw element (FIG. 1, Ref. 6) and Flat Metal and Pin element (FIG. 1, Ref. 4), secure connection of said Base Cylindrical Member A to Connected Cylindrical Adjustable Member B. Said Screw element extends into assembly holes of said Flat Metal elements positioned and flushed against each side of said Base Cylindrical Member A, extends through journal holes at distal end of said Connected Base Cylindrical Member A where assembly holes and journal hole communicate. Pin element extends into assembly hole at proximal end of said Flat Metal elements into journal hole at distal end of said Connected Cylindrical Adjustable Member B where second assembly holes communicate with journal hole. Free of any restrictive components, such that said Connected Cylindrical Adjustable Member B can be freely rotated about axis. Angle position of said Connected Cylindrical Adjustable Member B enabled by (FIG. 2; Ref. 13) Cylindrical Angle Position Adjustment element. Preferred material of interconnection Angle Position Adjustment element is aluminum or alloy. Affixed on said Angle Position Adjustment element, a Cross Metal Piece and knob element (FIG. 3; Ref 13B) as means to enable motion of said Angle Position Adjustment element. Portion of said Cylindrical Angle Position Adjustment extends within base of said Base Cylindrical Member A. A portion of said Cross Metal element protrudes out on non-occupant facing side (FIG. 2; Ref. 13B) of invention. Endings fitted with said (FIG. 1; Ref. 5) Fitted Cap element. Interconnection component, a Bracket element (FIG. 9; Ref. 17) which wrap around distal end of said Cylindrical Multiple Curve Member D (FIG. 11) as means to enable attachment to said Cylindrical Adjustable Member B. Screw element (FIG. 13; Ref. 17B) assist in connection. Connection of said Connected Cylindrical Member B to said Connected Cylindrical Member D, achieved by (FIG. 9; Ref.16) Pin with Knob element affixed to said Connected Cylindrical Adjustable Member B, as a means to secure. Functionality of said Connected Cylindrical Member B enabled by (FIG. 9; Ref. 16A) Parent Sleeve element, having (FIG. 9, Ref. 8C) Insertion Hole element as means to enable insertion, Child Sleeve (FIG. 9; Ref. 16B), whereas to slide within said Parent Sleeve element. Said Retractable Pin element (FIG. 9; Ref. 8D) affixed to said Child Sleeve element whereas to be inserted into (FIG. 9; Ref. 8C) Insertion Hole element on said Parent Sleeve element. Said Process of pin insertion; 1.Moves with said Child Sleeve element. 2.Position said Retractable Pin element under said Insertion Hole element on said Parent Sleeve element. 3.Said Spring element, as means to enable retraction of said Retractable Pin element, coils. Said Retractable Pin element thrust upward into said Insertion Hole element. Process is a means to secure adjusted length of said Connected Cylindrical Adjustable Member B. Said Connected Cylindrical Multiple Curve Member D shape are fitted with (FIG. 11; Ref. 18B) Grip Cushion element, as means to enable handling and reduce slippage. Preferred material of said Grip Cushion element is rubber. Positioned at distal end of said Connected Cylindrical Multiple Curve Member D, (FIG. 11; Ref, 19) Insertion Cylinder element as means to attach Pin and Knob element (FIG. 19; Ref. 16). (FIG. 13; Ref 16G) Rotate knob, Pin is rotated, positioned crossed opening of said Insertion Cylinder element, as means to affix said Connected Cylindrical Multiple curve Member D to said Connected Cylindrical Adjustable Member B. While the above description contains many specialties, they should not be construed as limitations on the scope of the invention, but as exemplifications of the presently-preferred embodiments thereof. Many other ramifications and variations are possible within the teachings of the invention. For example, the Fitted Cap can have non-round shape (FIG. 1; Ref.5); hinges (FIG. 2; Ref. 7) can be positioned on both sides of a bar for usage on the left or right side of a stroller, eliminating the right-side operation restriction; the Counter-Weight Cylindrical Adjustable Member C (FIG. 6) can be detachable from Base Cylindrical Member A; Counter-Weight Cylindrical Adjustable Member C (FIG. 6) can be a separate embodiment; the adjustable lengths of Cylindrical Members can be of vary; the Strap (FIG. 7) can be designed as a piece of leather with Buckle and holes. Thus the scope of the invention should be determined by the appended claims and their legal equivalents rather than by the examples given. From the description presented a number of advantages of a Detachable Multiple Cylindrical Adjustable Member Apparatus become evident: Adjustable. Varying adjustable lengths of said Cylindrical Members accommodate varying heights of Chaperones. Options. Multiple Apparatus' can be attached alongside vehicle. Security. Communication. Increase chaperone and occupant interaction and communication. Simple operation. Lightweight.

### PREFERRED EMBODIMENT—OPERATION

The manner of in which to use a Detachable Adjustable Multiple Cylindrical Members Apparatus to steer and maneuver a vehicle does not differ from present day approach, which is to apply pressure by a chaperone to push and turn a vehicle. However, the manner in which this is accomplished differs. Invention positions a chaperone alongside vehicle compared to behind the vehicle, which is present day operation. To operate my invention, Attach said (FIG. 4) Clamping element side of vehicle. Motion said (FIG. 5; Ref. 20B) Swing-to-Lock Bracket element onto (FIG. 5; Ref.20D) Holder element whereas to create opposite tension against said Swing-to-Lock Bracket element, as means to secure attachment onto vehicle. Slide said Base Cylindrical Member A into said clamping element by sliding said Hinge element (FIG. 2; Ref. 7) into hook said holder element atop said clamping element whereas to secure invention to vehicle. Rotate (FIG. 2; Ref. 13B) knob element, as means to slide Angle Position Adjustment element (FIG. 2; Ref.13) into (FIG. 1; Ref. 2A) Angle Hole element as means to secure angle position of a Connected Cylindrical Adjustable Member B for operation. Adjusting length of said Cylindrical Adjustable Members accomplished by the preceding process. Push (FIG. 9; Ref.8D) Retractable Pin element downward. Slide said (FIG. 9; Ref.16B) Child Sleeve element within said (FIG. 9; Ref. 16A) Parent Sleeve element. Said Retractable Pin retracts upward, insert (FIG. 9; Ref. 8C) Insertion Hole element. Process is a means to secure adjustable length. Process secure angle position of Connected Cylindrical Multiple Curve Member D. Push (FIG. 9; Ref. 16E) Insert Pin element downward and spring coils, Rotate (FIG. 9; Ref. 16D) Rotation Sleeve element to side of (FIG. 9) Connected Cylindrical Adjustable Member B. Said Spring uncoils, insert Insert Pin element into (FIG. 9; Ref. 8C) Insertion Hole element in Rotation Sleeve element. Rotate (FIG. 11) Connected Cylindrical Multiple Curve Member D element. Proximal end of Connected Cylindrical Multiple Curve Member D connects to proximal end of Connected Cylindrical Adjustable Member B. Rotate (FIG. 9; Ref. 17A) Retract T-Pin element extending into (FIG. 3A) Connected Cylindrical Adjustable Member B, as means to enable connection of said Cylindrical Multiple Curve Member D to said connected Cylindrical Adjustable Member B at an angle from vehicle.

### Conclusions, Ramifications, and Scope

Accordingly, it can be seen that the reader can see that my invention can be used to steer and maneuver a vehicle easily and conveniently, can be detached easily without damage to vehicle, and can be attached to varying sized structural bars. Additionally, two Attachment Apparatus' may be attached to vehicle, whereas to operate and position another alongside. Though the description above contains specificities. These should not be construed as limiting the scope of the invention but as merely providing illustrations of some of the presently preferred embodiments of this invention. Various other embodiments and ramifications are possible within it's scope. For example,

Permits production of varying size clamping elements to accommodate different widths of structural bars of a vehicle;

Permits an design option of a Counter-Weight Cylindrical Adjustable Member C to be a removable feature of the invention;

Provides cylindrical tubes with superior surface upon which one can label or print;

Provides an invention with non-slip grip;

Allows Apparatus to be stored easily;

Allows the invention to be multicolored. Protective cushions offers a surface which can be printed on;

Allows said cushions and said grip covering to be brightly colored for night usage or neon colored;

Provides a cylindrical tube to be used for other functions, such as a hanger for occupant's belongings

Provides a modest protective side shield for vehicle occupant from a pedestrian's hanging accessories;

Thus the scope of the invention should be determined by the appended claims and their legal equivalents, rather than by the examples given.

### SUMMARY

An Attachable/Detachable Adjustable Multiple Cylindrical Tube Apparatus comprising of a base cylindrical tube, a connection member, a cylindrical tube, a bracket, a steering cylindrical tube, a pivot pin, and a third cylindrical tube, connected to proximal end of said base cylindrical tube a, pivot pin extending through journal hole of said base cylindrical tube a extending into assembly holes of said cylindrical member, where said journal hole and assembly holes communicate, said pivot pin and said third cylindrical tube being free of restrictive components, whereby said third cylindrical tube can be freely pivoted about axis of said journal hole an infinite number of times without breaking said pivot pin or any other component. Connection member comprised of two side flat metals, a screw, and a pivot pin. Screw extending into assembly hole of said side flat metal A extending through journal hole of base cylindrical tube a extending into assembly hole of said side sheet metal B, where assembly holes and journal hole communicate. Said pivot pin extending through assembly hole at distal end of side flat metal a extending through journal hole of said cylindrical tube extending into assembly hole of said side flat metal b, where assembly holes and journal hole communicate. Said cylindrical tube and said pivot pin being free of any restrictive components, such that, said cylindrical tube can be freely pivoted about axis of said journal hole an infinite number of times without breaking said pivot pin or any other component. A screw extending through journal hole of said cylindrical tube extending through assembly holes at distal end of said bracket, where said journal hole and said assembly holes communicate. Said bracket surrounds distal end of said steering cylindrical tube, said bracket, said screw, are free of restrictive components, such that, steering cylindrical tube and said bracket can be freely pivoted about axis of said journal hole an infinite number of times without breaking said bracket or any other component.

What I claim as my invention is:

1. An Attachable/Detachable Adjustable Multiple Cylindrical Tube Apparatus comprising:
A Base Cylindrical Tube A
A Connection Member
A Cylindrical Tube B
A Bracket
A Steering Cylindrical Tube
A Pivot Pin, and
A cylindrical tube C connected to proximal end of said base cylindrical tube a, pivot pin extending through journal hole of said base cylindrical tube a extending into assembly holes of said cylindrical member C, where said journal hole and assembly holes communicate, said pivot pin and said cylindrical tube c being free of restrictive components, whereby said cylindrical tube c can be freely pivoted about axis of said journal hole an infinite number of times without breaking said pivot pin or any other component,
Said Connection Member comprising:
A Side Flat Metal A,
A Screw
A Pivot Pin
A Side Flat Metal B,
Screw extending into assembly hole of said side flat metal a extending through journal hole of base cylindrical tube a extending into assembly hole of said side sheet metal B, where assembly holes and journal hole communicate. Said pivot pin extending through assembly hole at distal end of side flat metal a extending through journal hole of said cylindrical tube B extending into assembly hole of said side flat metal B, where assembly holes and journal hole communicate. Said cylindrical tube B and said pivot pin being free of any restrictive components, such that, said cylindrical tube B can be freely pivoted about axis of said journal hole an infinite number of times without breaking said pivot pin or any other component. A screw extending through journal hole of said cylindrical tube b extending through assembly holes at distal end of said bracket, where said journal hole and said assembly holes communicate. Said bracket surrounds distal end of said steering cylindrical tube, said bracket, said screw, are free of restrictive components, such that, steering cylindrical tube and said bracket can be freely pivoted about axis of said journal hole an infinite number of times without breaking said bracket or any other component;
Said Cylindrical Tube B and C comprising;
A Large Cylindrical Tube
A Small Cylindrical Tube
Said Large Cylindrical Tube surrounding and encasing said Small Cylindrical Tube, whereby enabling said Small Cylindrical Tube motion within said Large Cylindrical Tube, Said Large Cylindrical Tube having Insertion Holes, Said Small Cylindrical Tube having affixed to body, a protruding Push Pin, as means to enable insertion into said Insertion Holes of larger cylinder, whereby enabling resizing of main embodiment;

2. The arrangement of claim 1 wherein said Cylindrical Tube B having affixed Cylindrical Rod, portion extending through side of said Cylindrical Member A, Said Cylindrical Rod having a Knob affixed at distal end, as means to enable motion of said Cylindrical Rod within said Base Cylindrical Tube A, Said Base Cylindrical Tube A having grooves cut within, as means to enable insertion into said Base Cylindrical Tube A, whereby enabling said Cylindrical Tube B to be positioned a number of degrees from said Base Cylindrical Tube A;

3. The arrangement of claim 2 wherein said Cylindrical Tube B proximal end connected to circular bracket with holes, said circular bracket with holes connected to proximal end of said base cylindrical tube a, as means to enable rotation of said cylindrical tube b, such that cylindrical tube b are free of restrictive components, such that, cylindrical tube b can be freely pivoted about axis where circular bracket with holes and cylindrical tube b communicate, an infinite number of times without breaking said circular bracket or any other component. Said bracket having adjustment cylinder extending into. Said adjustment cylinder having a knob affixed, as means to enable motion of adjustment cylinder. Said cylinder can be inserted into said holes of circular bracket with holes, whereby adjusting the number of degrees cylindrical tube b is positioned from said Base Cylindrical tube A;

4. The arrangement of claim 1 wherein said Large Cylindrical Tube having a Clamp Lever affixed at distal end, as means to enable circumference reduction of distal end of said Large Cylindrical Tube, whereby securing position Push Pin of said Small Cylindrical Tube flushed to Large Cylindrical Tube end. Said Clamp Lever having Handle, to push down to secure Clamp Lever resize. A Pivot Pin extending through journal hole of Handle extending to assembly hole of Clamp Lever, where assembly holes and journal hole communicate. Said Handle and said Pivot Pin are free of restrictive components, such that, Handle can be freely pivoted about axis of said journal hole an infinite number of times without breaking said Handle or any other component;

5. The arrangement of claim 4 wherein said Large Cylindrical Tube not having Insertion Holes. Said Small Cylinder Tube having Push Pins affixed, as means to enable length adjustment of main embodiment;

6. The arrangement of claim 5 wherein said Large Cylindrical Tube having a Clamp Lever affixed at distal end, as means to enable circumference reduction of distal end of said Large Cylindrical Tube, whereby securing position of Push Pin of said Small Cylindrical Tube flushed to Large Cylindrical Tube end. Said Clamp Lever having Handle, to push down to secure Clamp Lever resize. A Pivot Pin extending through journal hole of Handle extending to assembly hole of Clamp Lever, where assembly holes and journal hole communicate. Said Handle and said Pivot Pin are free of restrictive components, such that, Handle can be freely pivoted about axis of said journal hole an infinite number of times without breaking said Handle or any other component;

7. The arrangement of claim 3 wherein said Cylindrical Tube C is a separate attachable and detachable embodiment from said Cylindrical Member A;

8. The arrangement of claim 7 wherein said Base Cylindrical Tube A having affixed a Clamp Appendage, as means to clamp invention to an object;

9. The arrangement of claim 8 wherein said Clamp Appendage is a detachable separate embodiment, such that, said Clamp Appendage can be affixed to and removed from said Base Cylindrical Tube A. Said Base Cylindrical Tube A having affixed to side Hooks. Said Clamp Appendage having Hook Holders affixed on top, as means to enable Hooks to slide within. Clamp Appendage can be of varying sizes, whereby said Clamp Appendage can clamp onto various sized objects;

10. The arrangement of claim 1 wherein said steering tube is positioned alongside and connected at distal end to distal end of said cylindrical tube B by said connection member;

11. The arrangement of claim 1 wherein said Cylindrical Tube B and Cylindrical Tube C comprised of large cylindrical tube having motion, as means to slide over said Small Cylindrical Tube, Said Small Cylindrical Tube having Insertion Holes whereby said Large Cylindrical Tube having a Pin and a knob affixed, as means to insert into said insertion holes whereby adjusting length of main embodiment;
